(19) United States
(12) Patent Application Publication
(10) Pub. No.: US 2007/0288323 A1
(43) Pub. Date: Dec. 13, 2007

(54) Method and System for Verifying the Integrity of an On-Line Vendor

(76) Inventor: Dani Halevy, Netanya (IL)

Correspondence Address: IBM CORPORATION, T.J. WATSON RESEARCH CENTER, P.O. BOX 218, YORKTOWN HEIGHTS, NY, 10598, US

(21) Appl. No.: 11/422,744

(22) Filed: Jun. 7, 2006

(51) Int. Cl. G06Q 30/00

(52) U.S. Cl. 705/26; 705/26

(57) ABSTRACT

In a method for verifying to a web-purchaser that an on-line vendor is reputable, before effecting a purchase a document having content created by the web-purchaser is conveyed to the vendor prior to confirming a purchase, and is digitally signed by the vendor using a private key provided by a verification authority. Data representative of the signed document is returned to the purchaser who conveys it to a credit payment authority for verification. The document may be prepared by the vendor but the fact that it is personalized by the purchaser prior ti signing, guarantees that the purchaser can establish the authenticity of the document prior to conveying to verification authority for signature verification.

### FIELD OF THE INVENTION

This invention relates to e-commerce and, in particular, to improving the security of e-commerce transactions.

### BACKGROUND OF THE INVENTION

When considering the factors that have encouraged or discouraged the development of electronic commerce, almost always one of the primary issues which are raised is the question of “security”. Significant progress has been made in this field in the recent past to the extent that it can fairly be stated that security problems have been satisfactorily resolved relating to communications networks in general, and to commerce in particular. The possibility to send and receive information securely and secretly is an essential condition to the establishment of commerce and of all other activities on the Internet. Specifically, the secure transfer of details relating to credit cards is an essential requirement for conducting commerce over the Internet.

However, when attempting to examine what else has been done so far to increase the level of security, it is immediately apparent that in most cases the vendor is generally the center of attention. Most software programs relating to electronic commerce have been developed, in fact, for the use and benefit of the vendor: to increase the efficiency by which he handles purchase orders, to increase the security of collecting payment, the preparation and presentation of better catalogs and so on. Much less has been done from the perspective of the purchaser and it is believed that this explains the relatively slow progress of electronic commerce in many countries.

As stated, from the point of view of the purchaser's security, the single most significant advance relates to the use of credit cards. However, even within the context of “secure” transactions, there still remain several questions: To whom is payment being made? What is known about the vendor? How can we know—in advance—if the vendor is serious with a reputable business history? What has been his commercial behavior in the past?

In the global village in which we all live, thousands of vendors of goods and services offer their wares on the network without there being any adequate information relating to the above matters in respect of most of these vendors. Not infrequently, the vendors are located far away, sometimes we do not even know in which country their business premises are located if indeed they exist at all, or from where the goods are dispatched. Put simply, we do not know anything about most of the vendors, particularly those who are only small or medium-sized. Likewise, the theoretical possibility to instigate legal proceedings in the uncharted territories of the Internet constitute, in themselves, a factor militating against Internet commerce in whatever form. The lack of sufficient information about the vendor, prior to initiating an Internet transaction is believed to be a serious bottleneck in the development of electronic retail marketing.

EP1046976A2 published Oct. 25, 2000 in the name of Sun Microsystems Inc. discloses a method and apparatus for enabling a user to authenticate a system prior to providing any user-privileged information. Reference is also made to the background discussion in this publication, which describes many of the problems to whose solution the present invention is also directed, particularly the need for the client in a host based system to authenticate a host system. Authentication is achieved by sending a set of user identification information to the host and then requiring the host to send back a unique message. Only if the host is able to return the appropriate unique message will the user provide to the host any user-privileged information. In a client-host system, authentication is achieved by having the client perform an authentication check on the host. If the client determines that the host is authentic, then the client will send a unique message signifying to the user that the host is authentic. Only if the user receives this message will the user provide any user-privileged information to the host.

This mechanism assumes that a secret message of some sort was previously established between the client and the host, and so appears not to be applicable in those cases where a client wishes to establish secure communication with an unknown host for the first time.

There exists both on and off the Internet various means which may allow us to reduce the risk and to increase the knowledge at our disposal concerning a specific vendor. The website BBBOnLine (www.bbbonline.com), for example, belonging to the U.S. company Better Business Bureau, and enjoying the patronage of large well-known firms, allows access to basic information regarding vendors who are members of the system. Such a system relates to what is effectively a type of “seal program”, namely a characteristic seal appearing at vendor sites in the Internet and identifying members of the organization and providing a reliable symbol of their seriousness and level of integrity. As noted in the site itself, there exist other programs of this kind in the Internet, albeit allegedly not of the same quality.

BBBOnLine Reliability was launched in April 1997 as a way to help identify online businesses with a reliable track-record in the marketplace. Companies in BBBOnLine Reliability must be in business for at least one full year, are members of the BBB in their area, agree to BBB advertising standards and dispute resolution procedures, and are visited by a BBB representative at their place of business to confirm adherence to the program requirements.

Launched in March 1999, BBBOnLine Privacy awards seals to online businesses that have been verified to be following good information practices. These practices include clearly posted privacy policies meeting rigorous privacy principals (including notice to consumer, disclosure, choice and consent, access and security), monitoring and review by a trusted organization, and consumer dispute resolution.

Maintaining a database of reputable vendors is not of itself sufficient to protect against fraud because it does not prevent a fraudulent host for passing himself off as a genuine vendor. The fraudulent host can then intercept sensitive information, such as credit card details, which it can then use to effect fraudulent transactions. Above-mentioned EP 1 046 976 describes an arrangement that has been used by fake hosts to steal confidential credit card data from a user where a perpetrator builds a fake host and places it in a likely location, such as near a bank or a grocery store. The fake host looks and acts in all superficial respects like an authentic ATM that attempts either to read the user's credit card to extract the identification information pertaining to the user; or it accepts the card and prompts the user for his PIN. Such an arrangement can also be used to steal PINs in both PIN based and client-host systems, including e-commerce systems.

SSL (Secure Socket Layer) and TLS (Transport Layer Security) protocols provide for secure communication paths between a web browser in a user machine and a vendor that is verified by a Certificate Authority, such as VeriSign. Data passed between the web browser and the vendor site is encrypted and thus the risk of eavesdropping is reduced.

The possibility also exists to make use of electronic certificates to certify the identity of a vendor before initiating a business transaction as discussed at length in VeriSign's website. From the purchaser's perspective, great importance is attached to such certification particularly in addition to current basic information about the vendor and his behavior in business. And, of course, there always exists the possibility to investigate a potential vendor in depth before conducting a transaction by making use of sources of information supplied over the Internet (such as links and other sites containing references to the vendor, as well as the use of search engines and the like) or by more conventional methods (such as Yellow Pages, Dun & Bradstreet and the like). Such research is, at best, burdensome and expensive both in terms of time and money.

Certificates must be created offline and can be faked while SSL/TLS are browser-dependent, are vulnerable to faked browser's indications and may not work with the wrong version of the browser software. Moreover, the user is not sufficiently involved in the verification process.

For both the general public, on the one hand, and to credit card companies on the other, there are three important negative ramifications to the lack of data about vendors:
Electronic commerce does not develop to the extent that is technically possible because many potential purchasers are wary of participating in such commerce;
The advantages which ought to arise owing to widespread competition do not, in practice, find expression and the market continues to be, for the most part, dominated by a small number of large vendors; the smaller medium sized vendors—which constitute the majority—find it difficult to gain a foothold; and
When, notwithstanding these factors, commercial transactions are performed, the purchasers—and ultimately the credit card companies—are commonly damaged by fraudulent activities. It has been postulated that some 25% of such fraudulent activities are done using credit cards. Amongst these, a large number are related to a failure to meet the conditions of business practice in the case of a lack of complete information, as is common with many businesses involved in electronic commerce.

WO0163878A1 published Aug. 30, 2001 in the name of Tradesafely Com Ltd. discloses a method and apparatus for Internet web site authentication. To authenticate an Internet web site, the web site is verified each time it is accessed by a user browser. On receipt of a page request, the web site generates a web page into which is embedded a URL site address or other unique identifier. A cookie, link to an image or Java applet or similar, for execution of the verification process may also be embedded or may be resident on the user browser. At the user, the browser instantiates the cookie, link to image or applet and extracts the URL site address or unique identifier which is sent, together with user ID to a verification server. The server performs comparison, comparing the URL address or unique identifier with a record of the correct identifier and/or URL address. Based on the comparison, an approval status is generated and sent back to the browser. This is displayed as a graphic in the browser or in any other way. The graphic includes an animated portion to increase security. The graphic also includes a user generated code or challenge which is stored on the verification server and which is sent back to the user upon successful authentication.

Disadvantages of this approach are the same as those mentioned above relating to dependence on the browser and the lack of user involvement in the verification process as well vulnerability to faked browser's indications.

JP2005065315A2 (Chen) published Mar. 10, 2005 and entitled “Encryption method for electronic commerce” discloses a system for providing secured e-commerce transactions, wherein a smart card and a computer software package are employed to protect Internet transactions by an encryption system of a hybrid key. Digital signatures and random numbers are used to ensure an integrity characteristic and an authentication characteristic. This publication does not relate to online web-site authentication.

US 2003/0191945 published Oct. 9, 2003 and entitled “System and method for secure credit and debit card transactions” relates to a method and system for conducting secure credit and debit card transactions between a customer and a merchant. The customer is issued with a pseudorandom security string by a host computer. The security string is sent to the customer's mobile telephone. A cryptographic algorithm running in a SIM card of the mobile telephone performs a hash on the security string. A customer PIN and a transaction amount are entered by a keypad of the mobile telephone. A three-digit response code is generated by the algorithm and then passed to the merchant. The merchant then transmits the response code, transaction amount and a card number to the host computer. The pseudorandom security string and PIN are retrieved from memory in the host computer. The host computer then applies the same algorithm to the security string, PIN and transaction amount so as to generate a check code. If the check code matches the response code transmitted by the merchant, the transaction is authorized. US 2003/0191945 requires the client to authenticate himself to the merchant, but does not require the merchant to authenticate itself to the client before acquiring client sensitive data.

US 2005/0055317 published Mar. 10, 2005 and entitled “Method and apparatus to provide secure purchase transactions over a computer network” relates to a method and structure for providing secure credit facility transactions for purchasing goods and services over a computer network. The method stores user's privileged information and other transactional data on the user's own computer. The method includes encryption of all information before or during its storage to the user's hard drive. The method includes the ability for the user to complete e-commerce transactions without revealing certain of the encrypted information, such as credit card numbers, to the merchant. During a purchasing transaction, the merchant delivers the encrypted information to the financial institution, where the user's private key is stored too, and used by the financial institution to decrypt user's data and confirm the transaction if the user's details (such as his address) are updated.

Reference is also made to “Prevent online identity theft—using network smart cards for secure online transactions” by Lu, H. K. and Ali, A. appearing in Information Security, 7th International Conference, ISC 2004 Proceedings (Lecture Notes in Computer Sci. Vol. 3225), 2004, p 342-353. This paper presents a method that combats online identity theft mechanisms that capture information on the computer before the information is encrypted. The key feature of this method is the use of secure network smart cards to establish secure connections between the smart card and remote trusted Internet nodes. Using this end-to-end secure connection, one can securely exchange confidential information between the smart card and a trusted remote server. Any intermediate node, including the host computer to which the smart card is connected, cannot compromise this secure connection.

The solutions suggested in the prior art require the use of additional hardware such as smart cards or mobile telephones, or require customized web browsers that access software agents or cookies that must first be stored in the client computer.

It would be desirable to provide a method for authenticating an on-line vendor that does not require that the vendor be a priori familiar to the user and that requires neither any hardware beyond a conventional computer nor any specialized software other than a conventional web browser.

### SUMMARY OF THE INVENTION

It is an object of the present invention to provide a method and system for authenticating an on-line vendor that does not require a purchaser to have any hardware beyond a conventional computer that does not require any specialized software other than a conventional web browser.

This object is realized in accordance with a first aspect of the invention by a method for verifying to a web-purchaser that an on-line vendor is reputable before effecting a purchase. The method includes providing to the vendor prior to confirming a purchase with a customized document having content created by the web-purchaser and receiving data representative of a signed customized document bearing the content, and using the data to obtain an indication as to whether the on-line vendor is reputable prior to authorizing said purchase.

Embodiments of the present invention assume that the verification authority maintains a database of reputable on-line vendors in a manner similar to that described above with reference to Better Business Bureau. However, embodiments of the present invention add two layers of security that protect against fraudulent hosts emulating genuine vendors. The first additional layer of security resides in the fact that digital signature of the document is based on an asymmetric encryption scheme (such as RSA) using keys provided confidentially to trusted vendors only by the credit card company. The second additional layer of security resides in the fact that it is not possible for the host to anticipate what content will be sent by the user and thus it is impossible to prepare in advance a signed document. In other words, the fact that verification of the host involves authenticating a document that is prepared or at least customized by the purchaser during the stage of verification and prior to entering confidential information, significantly reduces the likelihood of fraud.

The signed document may be conveyed to the web purchaser “as is” but more typically is hashed so as to produce data that is representative of the signed document but has a very much reduced data content.

In accordance with a second aspect, the invention provides a method for assisting an on-line vendor to reassure a potential purchaser that the on-line vendor is reputable prior to the purchaser effecting a purchase. The method includes digitally signing the document using a private key issued to the on-line vendor by a verification authority, and conveying data representative of the customized document to a remote device for authenticating the customized document and conveying to the web purchaser information allowing the web purchaser to determine whether the on-line vendor is reputable prior to authorizing said purchase.

The customized document may be conveyed by the web-purchaser to the vendor and digitally signed by the vendor prior to sending to a verification server for verifying that the signature belongs to that of an authorized vendor.

In accordance with a third aspect, the invention provides an on-line vendor system being adapted to reassure a potential purchaser that he is reputable prior to the purchaser effecting a purchase. The on-line vendor system includes a first communication port for receiving a customized document having content created by the web-purchaser, and a second communication port coupled to the first communication port for conveying data representative of the customized document to a remote device for allowing remote verification of the customized document.

In accordance with a fourth aspect, the invention provides a client system for verifying that an on-line vendor is reputable before effecting a purchase. The client system includes a customization unit for creating or customizing a document, a first communication port coupled to the customization unit for conveying said document to a vendor computer, and a second communication port for receiving from a verification authority an indication attesting to whether or not the vendor is trustworthy.

In an alternative embodiment, a “reduced” client is provided, where the computer software installed on the client machine is minimal. In such an embodiment, the client does not need to create documents by himself but fills forms given to him by the vendor site. The independent communication channels for sending signatures to the verifier to verify for verification and to get for receiving the verifier's confirmation/rejection for these signatures may be simply a protected email address accessed via a secure web-site, e.g. YAHOO mail system, the verifier being responsible for the security of such a system.

Minimizing the client minimal speeds secure purchasing process for users and renders it more widely available since users do not have to use their specific computer where certain software and devices are installed. Instead they need only own an email address accessed via a web site, and they can commit secure purchases from almost every computer in any Internet café, the only requirement from this computer being that it will have a reasonable browser, which in any case is standard. Of course, a necessary condition for a secure purchasing is appropriate software running on the Vendor web site, but this does not limit the computer that the purchaser can use.

In accordance with yet another aspect of the invention there is provided a verification server for verifying to a web-purchaser that an on-line vendor is reputable before effecting a purchase. The verification server includes a memory storing therein a database of trusted vendors and a respective public encryption key, a signature verification unit coupled to the memory for receiving a signed document purporting to originate from a specified vendor and using the public key to check whether the document is signed by the specified vendor, and a communication channel coupled to the signature verification unit for communicating to the web-purchaser data indicative of whether the document is authentic.

In some variants, the verification authority gets a signed/unsigned document from an authorized vendor (i.e. registered at the verification authority) via password, verifies/signs it (as appropriate) and sends the web-purchaser a signed document. It is the purchaser's responsibility to validate that the document has the customization he created. In another variant, the verification authority gets a document signed by the vendor directly from the web-purchaser for verification. It is again the web-purchaser's responsibility to validate that the document has the customization he created before he sends it to the verification authority for verification.

In yet another variant, verification is performed by a hardware unit residing on the client's side, comprising only one public key, verification unit and an appropriate user interface. The verification server signs the customized document received by a vendor that is registered in the server's database and signs the document with its own private key. The signed document is then conveyed to the client where the hardware unit uses the public key to authenticate that the signed document was indeed conveyed by the verification authority. The web-purchaser is thereby provided with the two critical elements which establish the vendor's authenticity: namely, the fact that the document received by the verification server is the same one customized by the web-purchaser and conveyed to the vendor; and the fact that the verification server vouches for the vendor's integrity.

In yet another embodiment the same two critical factors are provided without requiring the vendor to sign the customized document but rather to convey the customized document to the verification server while identifying itself in a secure and reliable manner. This can be done by means of a password that the vendor receives on registering with the verification server and/or by virtue of a secure communication channel between the vendor and the verification server.

Likewise some embodiments of the invention rely on a secure communication channel between the verification server and the web-purchaser, thus obviating the need for the verification server to convey a signed document to the web-purchaser.

### BRIEF DESCRIPTION OF THE DRAWINGS

In order to understand the invention and to see how it may be carried out in practice, some embodiments will now be described, by way of non-limiting example only, with reference to the accompanying drawings, in which:

FIG. 1 is a pictorial representation of a prior art e-commerce system;

FIG. 2 is a block diagram showing functionality of a client computer according to an embodiment of the invention for verifying on-line vendors in the system of FIG. 1;

FIG. 3 is a block diagram showing functionality of a vendor computer according to an embodiment of the invention for allowing a web purchaser to authenticate an on-line vendor in the system of FIG. 1;

FIG. 4 is a block diagram showing functionality of a verification server according to an embodiment of the invention for allowing a web purchaser to authenticate an on-line vendor in the system of FIG. 1;

FIG. 5 is a flow diagram showing the principal operations performed by the client computer shown in FIG. 2; and

FIG. 6 is a flow diagram showing the principal operations performed by the vendor computer shown in FIG. 3.

### DETAILED DESCRIPTION OF EMBODIMENTS

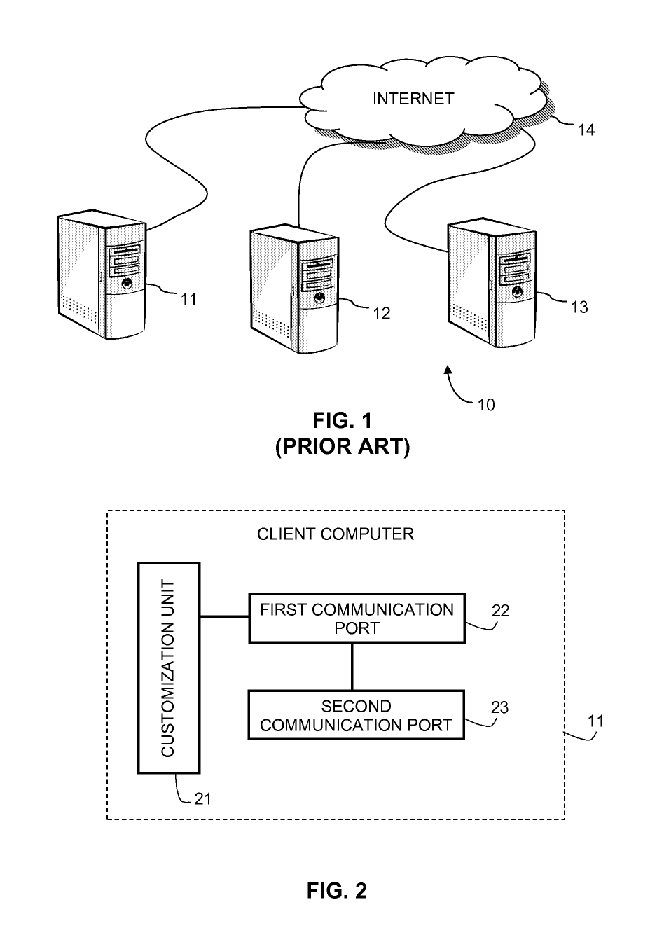

FIG. 1 shows pictorially a typical prior art system designated generally as 10 for allowing a web-purchaser at a client computer 11 to verify the reputation and integrity of an on-line vendor at a vendor computer 12 before actually completing an on-line purchase and submitting sensitive data such as credit card details. A verification server 13 communicates with the client computer 11 and with the vendor computer 12 over the Internet 14.

As shown in FIG. 2 the client computer 11 comprises a customization unit 21 for creating or customizing a document. The document may be created from scratch by the client computer 11 but more typically it is originated by the vendor computer 12 and conveyed to the client computer 11, where it is customized by the customization unit 21. A first communication port 22 is coupled to the customization unit 21 for conveying the customized document to the vendor computer 12 and for receiving from the vendor computer 12 data representative of a signed document. A second communication port 23 is coupled to the first communication port 22 for conveying the received data to the verification server 13 for verification and for receiving from the verification server 13 an indication attesting to whether or not the vendor is trustworthy. The verification server 13 may be operated by a credit payment authority or maybe operated in conjunction therewith.

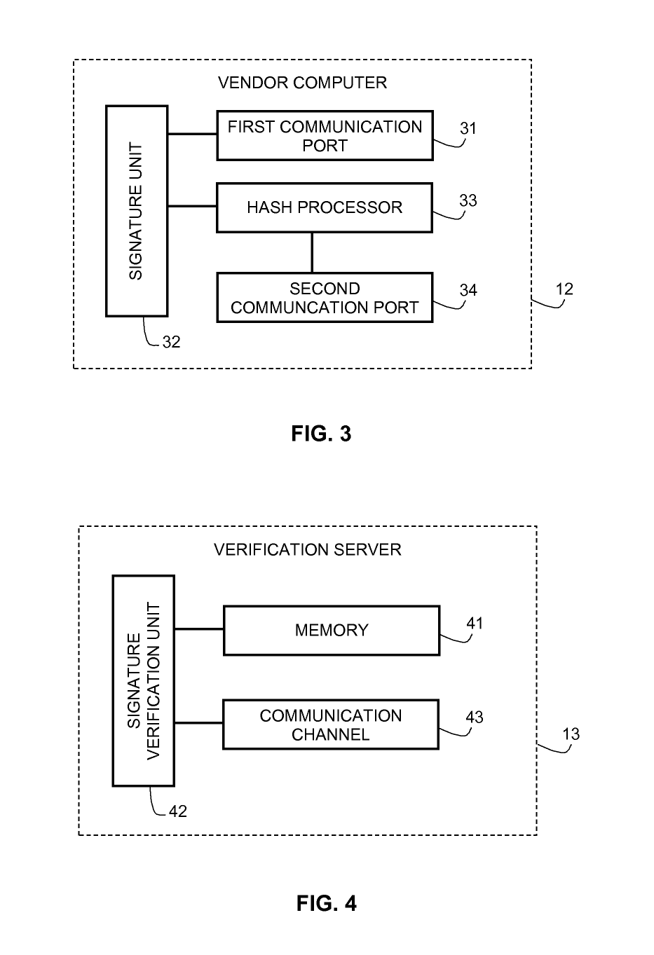

As shown in FIG. 3, the vendor computer 12 comprises a first communication port 31 that is adapted to be coupled to the client computer 11 for receiving a document having content created by the web-purchaser. A signature unit 32 is coupled to the first communication port 31 for digitally signing the document using a private key issued to the on-line vendor by the verification authority. A hash processor 33 is coupled to the signature unit 32 for hashing the signed document to generate data that is representative of the signed document and has a very much reduced data content. A second communication port 34 is coupled to the hash processor 33 for conveying the hash data to the web purchaser for allowing the web purchaser to forward the hash data to the verification authority for verification. It will be appreciated that the hash processor 33, while desirable, may be omitted in which case the second communication port 34 is coupled directly to the signature unit 32 for conveying the un-hashed signed document to the web purchaser.

As shown in FIG. 4, the verification server 13 comprises a memory 41 storing therein a database of trusted vendors and respective public and private encryption keys. A signature verification unit 42 is coupled to the memory 41 for receiving a signed document purporting to originate from a specified vendor and checking whether the document is signed by the specified vendor. A communication channel 43 is coupled to the signature verification unit 42 for communicating to the web-purchaser data indicative of whether the document is authentic.

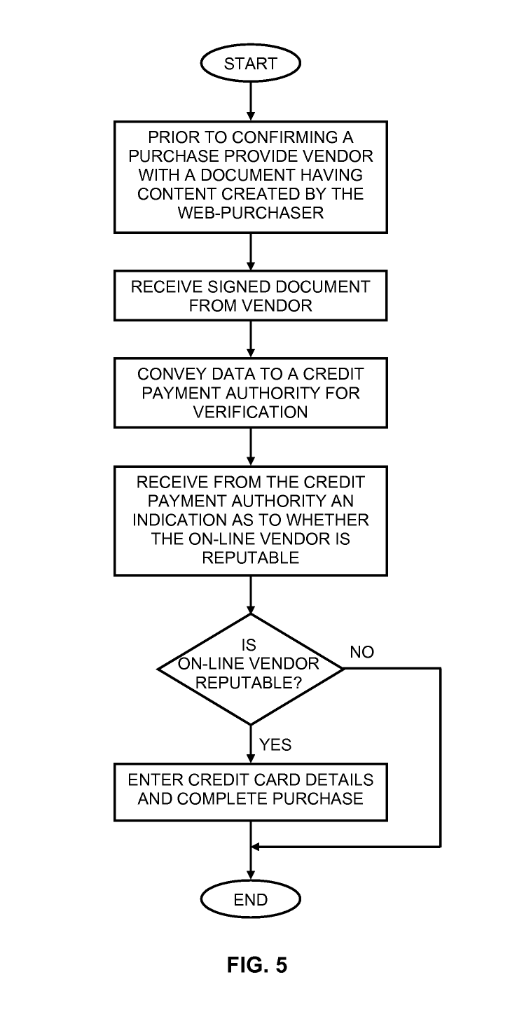

FIG. 5 is a flow diagram showing the principal operations performed by the client computer 11 for verifying to a web-purchaser that an on-line vendor 12 is reputable before effecting a purchase. Thus, prior to confirming a purchase the client computer 11 provides a document having content created by the web-purchaser to the on-line vendor 12 and receives back from the vendor data representative of a signed document bearing the content and signed by the on-line vendor using a private key issued by the verification authority. The client computer 11 then conveys the received data to the verification authority for verification, and receives from the verification authority an indication as to whether the on-line vendor is reputable. If so, the client computer 11 may authorize the purchase by communicating to the vendor sensitive data such as credit card details and so on. The digital signature serves to identify the vendor to the verification authority and ensures that the on-line which signed the document is genuine. But this alone does not prove that the client computer is connected to this vendor, since as noted above it is known for unscrupulous vendors to pass themselves off as genuine vendors by using similar home pages as genuine on-line vendors. The invention adds a layer of protection by virtue of the document customization, which guarantees that the signed document received by the client is the one that the client sent and ensures that nominally identical purchasing operations performed even by the same user are different. This precludes the possibility that a fraudulent vendor might have in stock a document that was signed by the genuine vendor and then convey this page to the verification authority. It also provides feedback to the purchaser that on-line vendor who he thinks is offering to sell him goods is the same vendor who is authorized by the verification authority.

According to an embodiment of the invention, the document is originated by the vendor, conveyed by the vendor to the client and customized by the client, prior to conveying to the verification authority. The document is digitally signed using a private key provided to trusted vendors only by the verification authority, which maintains a record of the corresponding public key for decrypting the signed document in order to establish whether it were indeed signed by the trusted vendor which supposedly signed the document. The signed document may be sent by the client computer 11 to the verification authority via an independent communication channel, not necessarily the Internet thus adding another layer of security. Likewise, yet a further layer of security may be added by the verification authority conveying an indication of trustworthiness to the client computer via an independent communication channel. This prevents a fraudulent vendor intercepting a negative indication and conveying a positive indication to the client. The independent communication channel may be constituted by a telephone channel or a virtual private network (VPN), where volume of transactions justifies the expense. In any case, even when the indication is sent over the Internet, as is typical, SSL or TLS may be used to render the communication secure.

In such an embodiment, since the document is not signed by the vendor, some other mechanism must be employed to allow the verification authority to establish unambiguously that the vendor is genuine and that to provide the required feedback to the purchaser that it this same vendor in whose products the purchaser has shown interest. One possible approach to meeting these requirements is that in order to communicate with the verification authority, the vendor authenticates himself using his password (but other authentication methods are possible as well). The verification authority conveys the document and the signature to the web-purchaser, who is able to identify the document he customized, and possibly to locally compute hardware verification in order to verify the signature (depending on the variant).

It will be understood that the figures depict the above-described embodiment of the invention, and modifications are required to implement alternative embodiments of the invention. For example, in the variant where the document is not signed by the vendor, but by the verification server, at least the following changes are required:

The first communication port of a client computer shown in FIG. 2 is not used to get the signed document from the vendor (which is not the signer in that variant).

The vendor computer shown in FIG. 3 does not have a signature unit and hash processor and uses its second communication port to convey documents to the verification authority, which signs it.

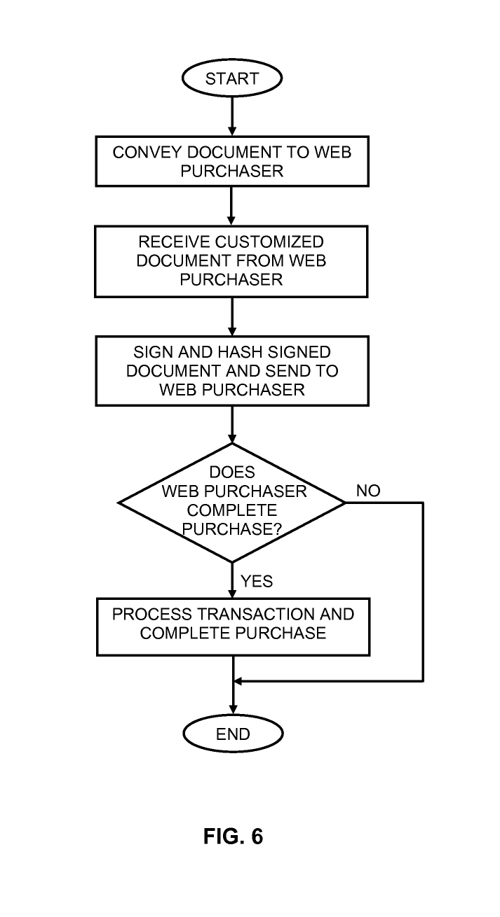

The memory of the verification server shown in FIG. 4 stores only a database of trusted vendors, not their public and private keys pairs, because only the verification server actually signs, using its private key. FIG. 6 is a flow diagram showing the principal operations performed by the vendor computer 12 for assisting an on-line vendor to reassure a potential purchaser that he is reputable prior to the purchaser effecting a purchase. Thus, the vendor computer 12 receives a document having content created by the web-purchaser, digitally signs the document using a private key issued to the on-line vendor by a verification authority, and conveys data representative of the signed document, typically after hashing, to the web purchaser for allowing the web purchaser to forward the data to the verification authority for verification. In use, the on-line vendor typically provides a “check me” icon in his web page, inviting the web purchaser to click on the icon to verify the on-line vendor prior to purchase. As noted above, the vendor computer may convey a prepared document to the web purchaser in response to the web purchaser clicking on the icon for allowing the purchaser to customize the document prior to the vendor signing it.

Although an embodiment of the invention has been described with particular reference to payment by credit card, it will be understood that the invention is not limited to any particular method of payment, and certainly not to payment by credit card alone.

Thus, the invention contemplates a variant where the verification on the client side is done using hardware, which is not physically connected to the computer and is thus not connected to the Internet and not exposed to any software attack. Such hardware may for example be a keyboard extension with an independent unit where verification of signature can be executed.

According to another variant of the invention, the actual signature on the user's document is done not by the vendor site, but by the verification authority. An advantage of this variant is that the verification authority does not have to deal with the issue of handling key distribution to vendors, enforcement of keys' expiration, and so on. The verification authority still requires a database of all vendors which may connect to its site using password. The implementation of this variant requires online communication between vendors and verification senders and changes the architecture and impacts on the required communication ports and computer programs at each entity.

Other embodiments include the following:
1. The user gets signature (produced by verification authority) from the vendor, and sends it again to verification authority for verification.
2. The user directly gets signature from verification authority and possibly validates it via a hardware component, such as a keyboard extension as described above.
3. There is no signature at all. Before completing purchasing operation, the vendor logs in to the verification center's site and makes a request to send a verification message to the user. The user just waits for online confirmation of the site via an email on a secure channel (or other secure channel) before completing purchasing operation.
4. An additional related variant is a small change in the architecture, so that the vendor will not sign the document, but will convey the unsigned document to the verification authority rather than to the web-purchaser, and will let the web-purchaser and the verification authority complete the authentication process.

In variants 3 and 4 the vendor may, for instance, present to the web-purchaser a message-box saying “wait for message from verification authority” or something similar.

It will also be understood that the client and vendor computers according to the invention may be suitably programmed computers. Client computers may be just a computer with typical web browser. To support such a minimal client, the customization unit may be dispensed with, allowing the user to manually complete a dialog box created by the vendor site, which allows the purchaser to customize the form manually. Also, when using a minimal client, the vendor site typically implements the digital signature algorithm and the verification server typically stores a database of all subscribed vendors and implements the verification algorithm. Likewise, the invention contemplates a computer program being readable by a computer for executing the method of the invention. The invention further contemplates a machine-readable memory tangibly embodying a program of instructions executable by the machine for executing the method of the invention.

In saying this it is to be noted that some embodiments avoid using such programs on the computer or other remote device operated by the web-purchaser in order to permit the web-purchaser to employ a “minimal” client that allows any computer with a reasonable web-browser at any Internet-café can be used as a client machine. The need for client programs can be reduced or even avoided as follows:
by making the vendor responsible for creating documents, so that the user will only have to fill forms thus avoiding the need for client programs which create of customize documents automatically.
by receiving and sending data to verification authority via an independent and secure channel (such as e-mail system) that the user can access via its website (such as www.mail.yahoo.com) the security of which is guaranteed by the verification authority. It can be the user's responsibility to send mail asking the verification authority to verify a signature and to receive its response. This will serve the dual goals of making the user involved in the process and of minimizing the clients machine's requirements.

1. A method for verifying to a web-purchaser, using a site of an on-line vendor, that the on-line vendor is reputable before finalizing a purchase via said site, the method comprising:
providing to said vendor a customized document having unique content created by the web-purchaser;
receiving authentication data representative of a signed version of said customized document bearing said unique content; and
using said authentication data to verify that the on-line vendor is reputable according to a verification authority, prior to the web-purchaser authorizing said purchase.

2. The method according to claim 1, wherein using said authentication data to verify that the on-line vendor is reputable comprises:
conveying said authentication data to said verification authority for verification; and
receiving from the verification authority an indication as to whether the on-line vendor is reputable.

3. The method according to claim 1, wherein providing the customized document to the vendor comprises:
receiving a document from the vendor via said site;
customizing the document with said unique content so as to create said customized document; and
conveying the customized document to the vendor for signature.

4. The method according to claim 1, wherein the customized document is digitally signed using a private key provided by the verification authority to trusted vendors only.

5. The method in claim 1, wherein the customized document is conveyed by the vendor to the verification authority and is digitally signed by the verification authority.

6. The method according to claim 1, wherein using said authentication data to verify that the on-line vendor is reputable comprises:
using an independent local hardware component for verifying said data so as to authenticate a signature applied to said customized document.

7. The method according to claim 2, wherein said indication is received from the verification authority only if the vendor is authenticated.

8. The method according to claim 2, comprising conveying the authentication data to the verification authority via an independent communication channel.

9. The method according to claim 2, comprising receiving said indication from the verification authority via an independent communication channel.

10. A method for assisting an on-line vendor to reassure a potential web-purchaser, using a site of vendor, that the on-line vendor is reputable prior to the web-purchaser finalizing a purchase via said site, the method comprising:
receiving a customized document having unique content created by the web-purchaser; and
conveying authentication data representative of a signed version of the customized document bearing said unique content to a remote device for verification; and
conveying to the web purchaser an indication as to whether the on-line vendor is reputable prior to web-purchaser authorizing said purchase.

11. The method according to claim 10, comprising:
conveying said authentication data to a verification authority for verification so as to allow the verification authority to convey to the web-purchaser said indication as to whether the on-line vendor is reputable.

12. The method according to claim 10, wherein conveying said indication to the web purchaser comprises:
conveying the customized document to a verification authority for verifying the vendor; and only if the vendor is verified, signing the customized document and conveying said indication to the web-purchaser.

13. The method according to claim 10, wherein conveying said indication to the web purchaser comprises:
signing the customized document to create said authentication data; conveying the authentication data to a verification authority for verifying the vendor; and conveying said indication to the web-purchaser only if the vendor is verified.

14. The method according to claim 10, comprising creating said authentication data representative of the signed document by hashing the signed document.

15. The method according to claim 10, being initiated by the web purchaser clicking on an icon in a web page inviting a web purchaser to verify the on-line vendor prior to purchase.

16. The method according to claim 15, comprising conveying a prepared document to the web purchaser for customization with said unique content, in response to the web purchaser clicking on said icon.

17. An on-line vendor system adapted to reassure a potential web-purchaser, using a site of said vendor, that the on-line vendor is reputable prior to the web-purchaser finalizing a purchase via said site, the on-line vendor system comprising:
a first communication port for receiving a customized document having unique content created by the web-purchaser, and
a second communication port coupled to the first communication port for conveying authentication data representative of a signed version of the customized document bearing said unique content to a remote device for allowing remote verification of said on-line vendor.

18. The on-line vendor system according to claim 17, further comprising:
a signature unit coupled to the first communication port for digitally signing the customized document using a private key issued to the on-line vendor by a verification authority; wherein the remote device is a computer operated by the web-purchaser and adapted to forward said authentication data to the verification authority for verification.

19. The on-line vendor system according to claim 17, wherein the remote device is a computer operated by the verification authority, and adapted to verify said authentication data and to indicate to the web-purchaser whether the on-line vendor is reputable.

20. A computer program product comprising a computer useable medium having computer readable program code embodied therein for verifying to a web-purchaser, using a site of an on-line vendor, that the on-line vendor is reputable before finalizing a purchase via said site, the computer program product comprising:
computer readable program code for causing the computer to provide to said vendor a customized document having unique content created by the web-purchaser and for receiving authentication data representative of a signed version of said customized document bearing the said unique content; and
computer readable program code for causing the computer to use said authentication data to verify that the on-line vendor is reputable according to a verification authority, prior to the web-purchasers authorizing said purchase.
